(19) United States
(12) Patent Application Publication
(10) Pub. No.: US 2014/0300097 A1
(43) Pub. Date: Oct. 9, 2014

(54) CONDUIT STUB-UP CONNECTOR ASSEMBLY AND METHOD

(71) Applicant: Jeffrey Krause, Niles, IL (US)

(72) Inventor: Jeffrey Krause, Niles, IL (US)

(21) Appl. No.: 14/244,938

(22) Filed: Apr. 4, 2014

Related U.S. Application Data
(60) Provisional application No. 61/808,785, filed on Apr. 5, 2013.

(51) Int. Cl. F16L 37/26; F16L 21/00

(52) U.S. Cl. CPC F16L 37/26; F16L 21/007
USPC 285/4; 285/149.1

(57) ABSTRACT

A conduit stub-up connection assembly and method for coupling electrical conduit raceways. In an embodiment, a conduit stub-up connection assembly may include a connector including a connector body defining an opening for receiving a conduit end portion. The connector may also include a conduit retainer disposed relative to the opening. The conduit retainer may include at least one engagement feature for mechanically engaging the conduit end portion to resist removal of the conduit end portion relative to the connector. The coupling assembly may further include a conduit access form configured to be coupled relative to the opening of the connector body and extending longitudinally from the connector. The conduit access form may have a cross-sectional profile larger than a cross-sectional profile of the conduit end portion.

### CROSS-REFERENCE TO RELATED APPLICATIONS

The present application claims the benefit of U.S. provisional patent application Ser. No. 61/808,785, filed on Apr. 5, 2013, and entitled “Concrete Slab Conduit Stub-Up Connector and Sleeve and Quick-Connect Coupling,” the entire disclosure of which is herein incorporated by reference.

### TECHNICAL FIELD

The present disclosure generally relates to electrical conduit connections, and more particularly pertains to assemblies and methods suitable for in-slab conduit connections.

### BACKGROUND

In slab-on-grade, suspended slab concrete structures and slab-on-metal deck construction it is often a standard practice to install electrical conduit raceways within the body of the concrete slab. In order to be able to continue the conduit raceway vertically after concrete placement, the conduit is left extending above the top of slab approximately, for example six to twelve inches above the top of the slab, to allow the in-slab conduit to be coupled to the future extension of the raceway. This section of conduit extending above the final slab elevation is commonly referred to as a “conduit stub-up”. The conduit stub-up may enable the use of conventional conduit couplings, such as a set-screw fitting, which may sleeve over the two pieces of conduit being joined together.

Because the conventional conduit stub-up extend above the top surface of the concrete slabs, some form of protection may often be provided around conduit stub-ups to reduce the likelihood of damage to the conduit as well as injury to unaware and/or unsuspecting workers or laypeople. For example, damage to the conduit may make it difficult and expensive, perhaps prohibitively so, to couple the in-slab conduit to an additional section of conduit above the slab. In addition to possible damage to the conduit itself, the conduit stub-ups extending above the concrete slab may pose a tripping, impalement, or other safety hazard. For these reasons, various approaches may be utilized to identify and/or protect the protruding conduit stub-up (and/or to protect individual from safety hazards associated with the conduit stub-up). Examples of attempted safety measures may include spraying the conduit stub-ups and supporting structure with safety orange paint, attaching flags to the conduit stub-ups, covering the conduit stub-ups with miscellaneous objects such as CMU blocks and painting the objects a safety orange, and, in situations where groupings of conduit stub-ups occur in-line with each other, wood blocking may be strapped to stub-ups in order to protect them from damage and sprayed with orange safety paint to make them more visible.

### SUMMARY

According to an embodiment, a conduit stub-up connection assembly may include a connector including a connector body defining an opening for receiving a conduit end portion. The connector may also include a conduit retainer disposed relative to the opening. The conduit retainer may include at least one engagement feature for mechanically engaging the conduit end portion to resist removal of the conduit end portion relative to the connector. The conduit stub-up connection assembly may further include a conduit access form. The conduit access form may be configured to be coupled relative to the opening of the connector body and to extend longitudinally from the connector. The conduit access form may have a cross-sectional profile larger than a cross-sectional profile of the conduit end portion.

One or more of the following features may be included. The conduit retainer may include a ring. The at least one engagement feature may include a plurality of tabs extending radially inwardly from the ring and defining a nominal opening having a cross-sectional profile less than the cross-sectional profile of the conduit end portion. At least a portion of the tabs may be elastically deformable upon insertion of the conduit end portion into the opening of the connector body for mechanically engaging the conduit end portion. The conduit retainer may include a ring having a radial split allowing the ring to expand outwardly upon insertion of the conduit end portion into the opening of the connector body. The conduit retainer may be configured to electrically couple the conduit end portion with the connector body when the conduit end portion is received in the opening of the connector body. The connector may also include a collar releasably coupleable with the connector body to releasably retain the conduit retainer relative to the connector body.

The conduit access form may include a generally tubular member having a first end configured to be disposed at least partially around the connector. The first end of the generally tubule member may releasably engage the connector with the generally tubular member. The first end of the conduit access form may include a flange defining a recess configured to be disposed at least partially around the connector. The generally tubular member may include at least one region of mechanical weakness that may facilitate removal of at least a portion of the generally tubular member. The at least one region of mechanical weakness may include a perforation line. The perforation line may include a generally longitudinal perforation line on the generally tubular member. The perforation line may include a generally helical perforation line on the generally tubular member. The perforation line may include a generally circumferential perforation line on the generally tubular member.

The stub-up connection assembly may further include a plug assembly that may be removably disposed within the generally tubular member. The plug assembly may at least partially block the opening of the connector body.

According to another implementation, a conduit stub-up connection assembly may include a connector. The connector may include a connector body defining an opening having a first end for receiving a first conduit end portion and having a second end for receiving a second conduit end portion. A first conduit retainer may be disposed relative to the first end of the opening and a second conduit retainer may be disposed relative to the second end of the opening. Each of the first conduit retainer and the second conduit retainer may include at least one engagement feature for respectively mechanically engaging the first conduit end portion and the second conduit end portion to resist removal of the first conduit end portion and the second conduit end portion relative to the connector. The connector may also include a first collar and a second collar. Each of the first collar and the second collar may be releasably coupleable with the connector body to releasably retain the first conduit retainer and the second conduit retainer relative to the connector body. The conduit stub-up connection assembly may also include a conduit access form configured to be coupled relative to the first end of the opening of the connector body and extending longitudinally from the connector. The conduit access form may have a cross-sectional profile that is larger than a cross-sectional profile of the first conduit end portion.

One or more of the following features may be included. Each of the first conduit retainer and the second conduit retainer may include a ring having a plurality of tabs ending radially inwardly from the ring and defining a nominal opening having a cross-sectional profile less than a cross-sectional profile of the respective first and second conduit end portions. At least a portion of the tabs of each ring may be elastically deformable upon insertion of the respective first and second conduit end portions into the opening of the connector body for mechanically engaging the respective first and second conduit end portions.

The conduit access form may include a generally tubular member having a flange defining a recess configured to be disposed at least partially around the connector. The flange defining the recess may include one or more of a snap-fit feature and a press-fit feature to coupled the conduit access form relative to the opening of the connector body. The conduit access form may include at least one of a longitudinal perforation line, a helical perforation line, and a circumferential perforation line to facilitate removal of at least a portion of the generally tubular member.

According to yet another implementation, a method of providing an in-slab conduit stub-up connection may include coupling a first end of a grab ring conduit connector to a in-slab conduit. The method may also include coupling a conduit access form with a second end of the grab ring conduit connector. The conduit access form may extend above an intended slab grade. The method may also include pouring a concrete slab surrounding at least a portion of the in-slab conduit and the grab ring connector. The conduit access form may extend above the slab. The method may further include removing at least a portion of the conduit access form extending above the slab.

One or more of the following features may be included. Removing at least a portion of the conduit access form may include tearing the conduit access form along one or more of a longitudinal, a helical, and a circumferential line of mechanical weakness included in the conduit access form.

The method may also include inserting at least a portion of an above-slab conduit through an opening defined in the slab by the conduit access form. The at least a portion of the above-slab conduit may be inserted into the second end of the grab ring conduit connector to engage the at least a portion of the above-slab conduit with the grab ring conduit connector to resist removal of the at least a portion of the above-slab conduit relative to the grab ring conduit connector.

According to another implementation, a conduit stub-up connection assembly may include a connector including a connector body. The connector may also include a conduit retainer disposed relative to a first end of the connector body. The conduit retainer may include at least one engagement feature for mechanically engaging a first conduit end portion to resist removal of the first conduit end portion relative to the connector. The connector may also include a threaded feature associated with a second end of the connector body. The threaded feature may be configured for threadably engaging a cooperating threaded feature associated with a second conduit end portion for releasably engaging the second conduit end portion relative to the connector. The conduit stub-up connection assembly may also include a conduit access form. The conduit access form may be configured to be coupled relative to the second end of the connector body and extending longitudinally from the connector. The conduit access form may have a cross-sectional profile larger than a cross-sectional profile of the second conduit end portion.

One or more of the following features may be included. The conduit retainer may include a compression ring and a collar threadably engageable with the first end of the connector body. Tightening the collar relative to the connector body may reduce a cross-sectional profile of the compression ring to engage the first conduit end portion. The compression ring may include a split ring having at least one beveled surface. The at least one beveled surface may be configured to engage a cooperating beveled surface associated with one or more of the connector body and the collar. Engagement between at least one beveled surface of the compression ring and the cooperating beveled surface may reduce the cross-sectional profile of the compression ring.

The cooperating threaded feature associated with the second conduit end portion may include cooperating threads formed on the second conduit end portion. The cooperating threaded feature associated with the second conduit end portion may include a thread converter. The thread converter may include a first end including the cooperating threaded feature. The thread converter may also include a second end including an opening configured for receiving the second conduit end portion. The thread converter may also include a retention feature for retaining the second conduit end portion relative to the thread converter.

The conduit access form may include at least one of a longitudinal perforation line, a helical perforation line, and a circumferential perforation line facilitating removal of at least a portion of the generally tubular member. The stub-up connection assembly may also include a plug. The plug may include a first engagement feature configured to releasably retain the plug relative to the conduit access form. The plug may also include a second engagement feature configured to releasably retain the plug relative to a conduit access-way provided in a concrete body by the conduit access form.

According to another implementation, a method of providing an in-slab conduit stub-up connection may include coupling a first end of a conduit connector to a in-slab conduit. The method may also include coupling a conduit access form with a second end of the conduit connector. The conduit access form may extend above an intended slab grade. The method may also include pouring a concrete slab surrounding at least a portion of the in-slab conduit and the grab ring connector. The conduit access form may extend above the slab. The method may further include removing at least a portion of the conduit access form extending above the slab.

One or more of the following features may be included. Coupling the first end of the conduit connector to the in-slab conduit may include engaging one-or more grab ring retention features of the conduit connector with the in-slab conduit. Coupling the first end of the conduit connector to the in-slab conduit may include engaging a compression ring of the conduit connector with the in-slab conduit. Removing at least a portion of the conduit access form may include tearing the conduit access form along one or more of a longitudinal, a helical, and a circumferential line of mechanical weakness included in the conduit access form.

The method may also include inserting at least a portion of an above-slab conduit through an opening defined in the slab by the conduit access form. The at least a portion of the above-slab conduit may be inserted into the second end of the conduit connector to engage the at least a portion of the above-slab conduit with one or more grab ring retention features of the conduit connector to resist removal of the at least a portion of the above-slab conduit relative to the conduit connector. The method may include inserting at least a portion of an above-slab conduit through an opening defined in the slab by the conduit access form. The method may also include threadably engaging a threaded feature associated with the second end of the connector with a cooperating threaded feature associated with the above-slab conduit to resist removal of the at least a portion of the above-slab conduit relative to the conduit connector.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a conduit stub-up connection assembly consistent with an example embodiment of the present disclosure.

FIG. 2 schematically depicts an in-slab conduit section coupled with an above-slab conduit connection utilizing a conduit stub-up connection assembly consistent with an example embodiment of the present disclosure.

FIG. 3 schematically depicts an in-slab conduit section coupled with an above-slab conduit connection utilizing a conduit stub-up connection assembly consistent with an example embodiment of the present disclosure.

FIG. 4 depicts and exploded view of a grab ring conduit connector consistent with an example embodiment of the present disclosure.

FIG. 5 depicts an exploded cross-sectional view of a grab ring conduit connector consistent with an example embodiment of the present disclosure.

FIG. 6 diagrammatically depicts a conduit retainer of a grab ring conduit connector consistent with an example embodiment of the present disclosure.

FIG. 7 diagrammatically depicts a conduit retainer of a grab ring conduit connector consistent with an example embodiment of the present disclosure.

FIG. 8 diagrammatically depicts a conduit access form consistent with an example embodiment of the present disclosure.

FIG. 9 diagrammatically depicts a conduit access form consistent with an example embodiment of the present disclosure.

FIG. 10 diagrammatically depicts a plug consistent with an example embodiment of the present disclosure.

FIG. 11 diagrammatically depicts a plug consistent with an example embodiment of the present disclosure.

FIG. 12 is a partial exploded view of a conduit stub-up connection assembly consistent with an example embodiment of the present disclosure.

FIG. 13 diagrammatically depicts another example embodiment of a conduit stub-up connection assembly.

FIG. 14 is a perspective view of the example embodiment of the conduit stub-up connection assembly of FIG. 13.

FIG. 15 diagrammatically depicts an example embodiment of a conduit connector of the example embodiment of a conduit stub-up connection assembly of FIG. 13.

FIG. 16 diagrammatically depicts an example embodiment of a conduit connector of the example embodiment of a conduit stub-up connection assembly of FIG. 13.

FIG. 17 diagrammatically depicts an example embodiment of a conduit and thread converter assembly of the example embodiment of a conduit stub-up connection assembly of FIG. 13.

FIG. 18 diagrammatically depicts an example embodiment of a conduit access form and end cap of the example embodiment of a conduit stub-up connection assembly of FIG. 13.

FIG. 19 diagrammatically depicts an end portion of a conduit access form according to an example embodiment.

FIG. 20 is a cross-sectional view of the example embodiment of the conduit access form and end cap of FIG. 17.

### DETAILED DESCRIPTION OF EXAMPLE EMBODIMENTS

In general, implementations of the present disclosure may provide conduit stub-up arrangements that may allow in-slab conduit raceway sections to be coupled with conduit raceway sections extending above the slab. In some implementations, the conduit stub-up arrangements provided by the present disclosure may reduce, or eliminate, any features extending above the surface of the concrete slab prior to the point in time at which the above-slab conduit sections are coupled with the in-slab conduit sections. By reducing, or eliminating, features extending above the top surface of the concrete slab, the potential for damage to the conduit raceway (also referred to herein as “conduit”), which could make it difficult and/or expensive to join the damaged conduit raceway to additional conduit raceway section, may also be reduced and/or eliminated. As such, in some embodiments, the potential time and/or expense associated with repairing damaged conduit stub-ups may be reduced and/or eliminated. Similarly, the by reducing, or eliminating, features extending above the top surface of the concrete slab, the potential tripping, impalement, or other safety hazards may also be reduced and/or eliminated.

In some embodiments, conduit stub-up arrangements that reduce and/or eliminate features extending above the concrete slab may be accomplished by allowing two sections of conduit (e.g., an in-slab section of conduit disposed at least partially below the finish elevation, or top surface, of the concrete slab and an above-slab section of conduit extending upwardly from the concrete slab) to be joined or coupled together at least partially within the body of the concrete slab. In some embodiments, the coupling of the two conduit/raceway sections may be accomplished after the placement of the concrete and, in some situations, the two conduit sections may be coupled no sooner than a time when the above-slab conduit raceway element can be completely obstructed by partitions, walls, shafts, etc., of the building or structure being built. An embodiment of the present disclosure, may provide a chase, or opening into the surface of the concrete slab that may provide access to an embedded coupling within the body of the slab. The chase, or access-way, may allow an above-slab conduit raceway section to be inserted into the slab, and to be coupled to the embedded in-slab conduit raceway via the coupling. In an embodiment, the above-slab conduit raceway section may be inserted into the chase or access-way and coupled with the in-slab conduit raceway at a point in time at which partitions, walls, vertical shafts, etc., are being installed in the sequence of construction. In one example embodiment, prior to coupling the above-slab conduit raceway with the in-slab conduit raceway, no conduit may extend above the top surface of the concrete slab. Thus potential damage to the embedded conduit and/or potential trip or impalement safety issues resulting from conduit sections extending above top of slab elevation may be reduced and/or eliminated. While illustrative embodiments may pertain to in-slab conduit configurations, it will be appreciated that conduit stub-up connectors, connector assemblies and methods consistent with the present disclosure may be suitably used in connection with other applications, such as in-wall conduit raceway connections, and the like.

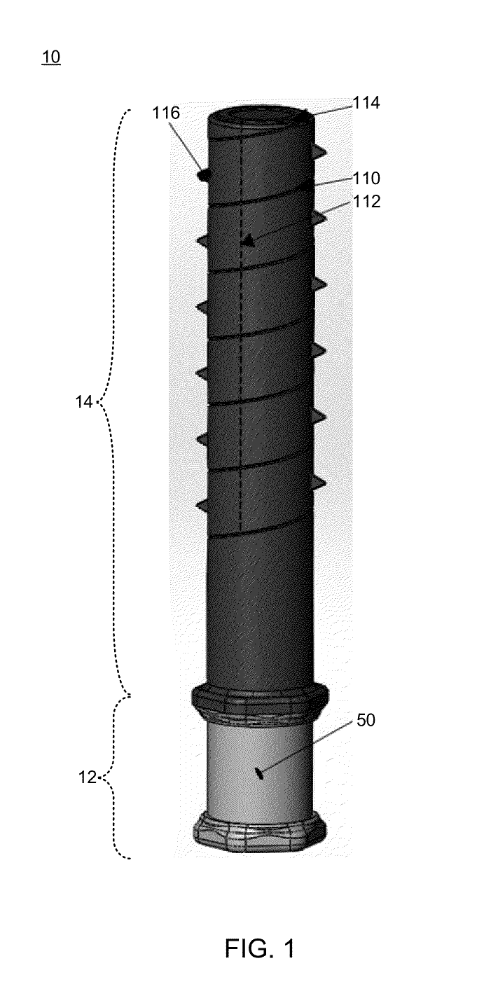

Referring to FIG. 1, an example embodiment of a conduit stub-up connection assembly (e.g., conduit stub-up connection assembly 10) is generally shown. Conduit stub-up connection assembly 10 may generally include connector 12 and conduit access form 14. Connector 12 may generally be configured for coupling two conduit raceway sections to one another. In some embodiments, connector 12 may mechanically couple two conduit raceway sections to one another. Further, in some embodiments, connector 12 may electrically couple two conduit raceway sections to one another. In an embodiment in which connector 12 may electrically couple two conduit raceway sections to one another, the two conduit raceway sections may be utilized as a continuous ground. When embedded in concrete (such as a concrete slab), conduit access form 14 may provide a chase, or access-way, in the concrete, e.g., from an exterior surface of the concrete to connector 12. For example, when embedded in concrete, conduit access form may provide a void in the concrete extending longitudinally from connector 12. The chase, or access-way, provided by conduit access form 14 may be sized to receive at least an end portion of a conduit raceway section.

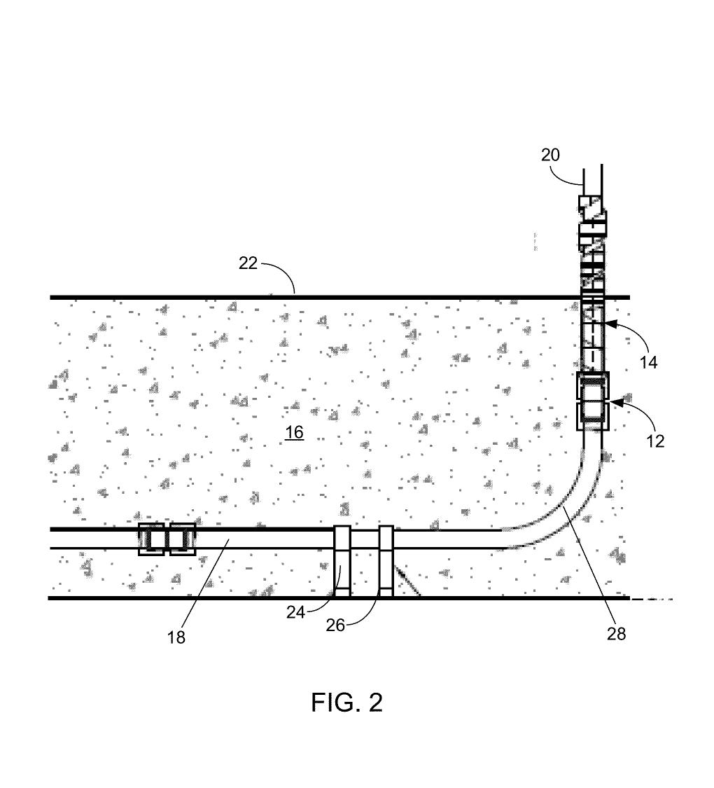

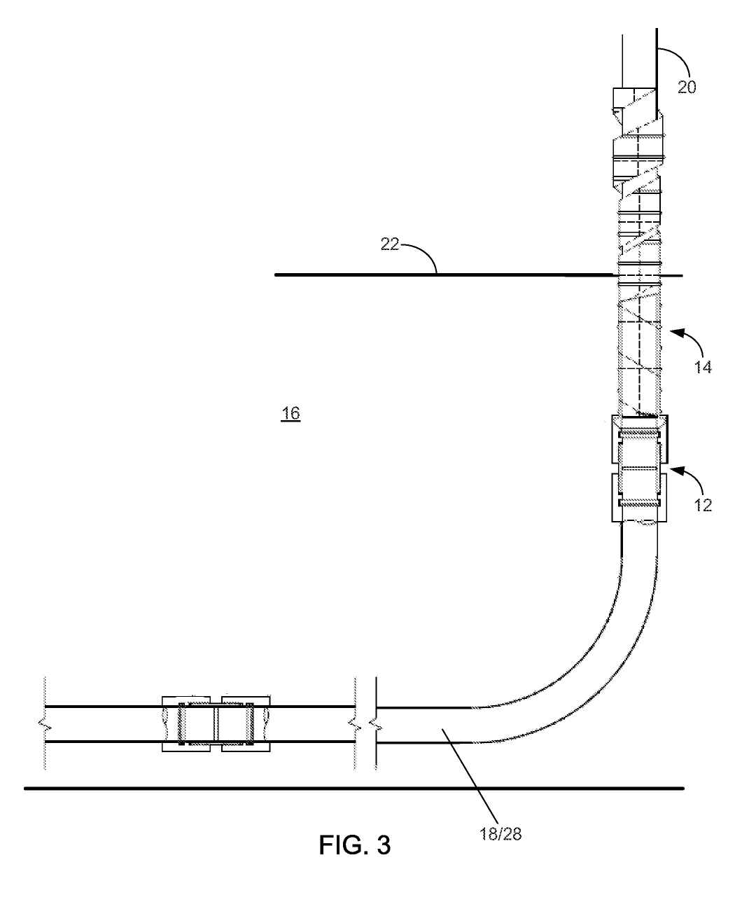

Referring also to FIGS. 2 and 3, an embodiment of a conduit stub-up arrangement embedded within a concrete slab (e.g., slab 16) is shown. Slab 16 may include, for example, a concrete slab utilized in connection with a slab-on-grade structure, a suspended slab concrete structure, a slab-on-metal deck structure, or the like. As shown, an in-slab conduit raceway section (e.g., in-slab conduit section 18) may be at least partially embedded in slab 16. In-slab conduit section 18 may be coupled with an above-slab conduit raceway section (e.g., above-slab conduit section 20). As shown, above-slab conduit section 20 may extend at least partially above slab 10. In-slab conduit section 18 and above-slab conduit section 20 may be coupled via connector 12 of conduit stub-up assembly 10. As shown in the example embodiment, connector 12 may be at least partially disposed below top surface 22 of slab 16. In some embodiments, such as the illustrated example embodiment, connector 12 may be completely disposed below top surface 22 of slab 16. Further, as shown, above-slab conduit section 20 may be received through a chase, or access-way, provided in slab 16 by conduit access form 14. As shown, the chase or access-way provided by conduit access form 14 may generally extend between connector 12 and top surface 22 of slab 16.

As shown in the illustrated example embodiment, connector 12 may be coupled to at least an end portion of in-slab conduit 18 at a point below top surface 22 of slab 16. In an embodiment, in-slab conduit 18 may be positioned relative to an intended slab, for example, through the use of stand-offs 24, 26, which may hold and/or orient in-slab conduit 18 in a desired position while the concrete of slab 16 is poured and hardened. Connector 12 may be coupled with in-slab conduit 18, and may be maintained in position at a point below the intended top surface 22 of slab 16, at least in part, by in-slab conduit 18 and stand-offs 24, 26. In an embodiment, coupling connector 12 with at least an end portion of in-slab conduit 18 may include coupling connector 12 to an end portion of a run of conduit that includes 90 degree bend in it (e.g., conduit elbow 28). For example, as shown conduit elbow 28 of in-slab conduit section 18 may provide a 90 degree bend such that an end portion of conduit elbow 28 that may be pointing generally vertically upward, e.g., to provide a conduit raceway directed out of slab 16. In another embodiment, coupling the connector to the in-slab conduit may include coupling the connector to a short piece of conduit that has a 90 degree bend in it, which can be attached to a horizontal run of conduit that will be buried, or embedded, in the slab once the slab is poured. According to either such situation, or other similarly suitable configurations, connector 12 may be generally oriented toward top surface 22 of slab 16.

Continuing with the foregoing example, when connector 12 is coupled with in-slab conduit 18 (and/or conduit elbow 28) to be generally oriented toward top surface 22 of slab 16, conduit access form 14 (which may generally extend longitudinally from connector 12), may similarly be generally oriented toward top surface 22 of slab 16. Further, conduit access form 14 may be sized, and/or conduit stub-up assembly 10 may be positioned (e.g., based upon, at least in part, the position of in-slab conduit section 18 and/or connector 12) such that conduit access form 14 may extend at least partially above the intended top surface 22 of slab 16. As such, when slab 16 is poured, conduit access form 14 may create a chase, or access-way, extending from top surface 22 of slab 16 down to connector 12. Further, conduit access form 14 may have a cross-sectional profile that is equal to, or greater than a cross-sectional profile of at least an end portion of above-slab conduit section 20. Conduit access form 14 may have a cross-sectional profile equal to, or greater than, the cross-sectional profile of at least the end portion of above-slab conduit section 20 when the cross-sectional profile of the end portion of above-slab conduit section 20 can fit within the cross-sectional profile of conduit access form. For example, when conduit access form 14 and the end portion of above-slab conduit section 20 each have a circular cross-sectional shape, conduit access form 14 may have a cross-sectional profile equal to, or greater than, the cross-sectional profile of the end portion of above-slab conduit section 20 when the diameter of the circular cross-section of conduit access form 14 is equal to, or greater than, the diameter of circular cross-section above-slab conduit section. It will be appreciated that one, or both, of conduit access form 14 and the end portion of above-slab conduit section 20, may have a cross-sectional profile other than circular. Accordingly, when concrete slab 16 is poured, conduit access form 14 may provide a chase or access-way configured to receive at least an end portion above-slab conduit section 20, such that the end portion of above-slab conduit section 20 may be coupled with connector 12.

In an embodiment, connector 12 may include a grab ring connector that may mechanically couple with at least an end portion of above-slab conduit section 20 when the end portion of above-slab conduit section 20 is longitudinally inserted into connector 12. When mechanically coupled with the end portion of above-slab conduit section 20, connector may resist removal of above-slab conduit section 20 relative to connector 12. Additionally, and as generally described above, in some embodiments, in additional to mechanically coupling above-slab conduit section 20 to resist removal, connector 12 may also electrically couple with above-slab conduit 20.

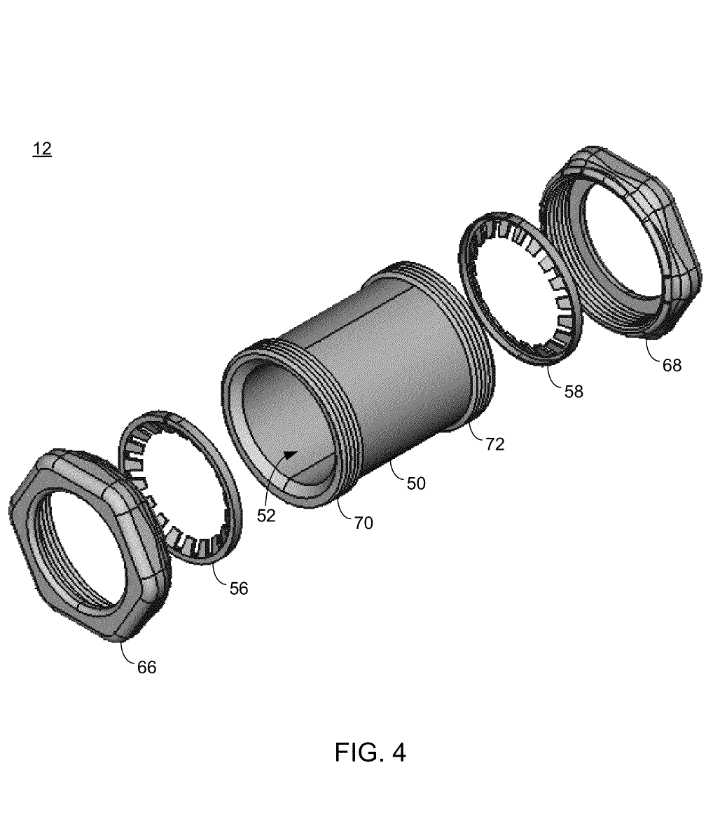

Referring to FIGS. 4 through 7, an example a grab ring type embodiment of connector 12 is shown. Connector 12 may generally include a connector body (e.g., connector body 50). Connector body 50 may generally define opening 52 for receiving a conduit end portion. For example, opening 52 may be configured for receiving an end portion of one or more of above-slab conduit section 20 and in-slab conduit section 18. In the illustrated embodiment, connector body 50 may generally include a tubular member, having generally circular cross-section opening 52 extending longitudinally through connector body 50. Opening 52 may have a cross-sectional profile that is equal to, or greater than, the cross-sectional profile of an end portion of one or more of in-slab conduit section 18 and above-slab conduit section 20, such that one or more of an end portion of in-slab conduit section 18 and above-slab conduit section 20 may be at least partially received within opening 52.

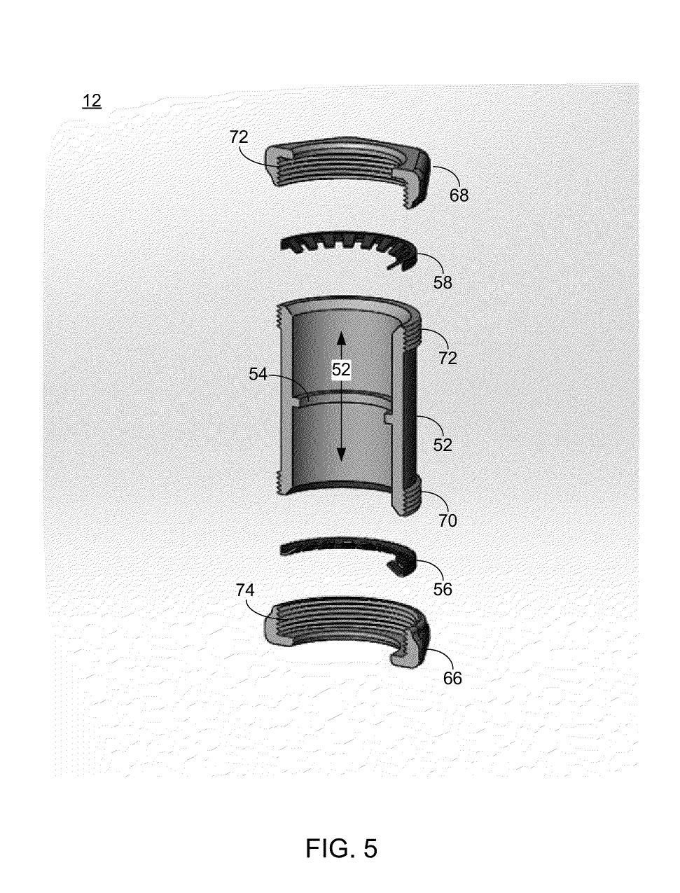

With particular reference to FIG. 5, in an embodiment, connector body 50 may include a conduit stop (e.g., conduit stop 54). Conduit stop 54 may define a region of opening 52 having a cross-sectional profile that is less than a cross-sectional profile of an end portion of a conduit section configured to be coupled with connector 12. In an embodiment, conduit stop 54 may limit the extent to which an end portion of a conduit section may be inserted into opening 52 of connector body. According to an example embodiment, conduit stop 54 may provide an indication that a conduit end portion has been correctly inserted into connector 12, e.g., by providing a positive stop that may provide tactile indication of complete insertion. In an embodiment in which connector 12 may be configured to at least partially receive a conduit end portion in each end of opening 52, conduit stop may prevent over insertion of one conduit end portion. Over insertion of one conduit end portion may, for example, result in the other conduit end portion being insufficiently inserted into connector 12, which could, for example, result in inadequate coupling between connector 12 and the insufficiently inserted conduit end portion. Consistent with the illustrated embodiment, conduit stop 54 is shown including an inwardly extending flange. It will be appreciated that other configurations may be equally utilized. For example, the conduit stop may include one or more inwardly projecting features, such as bumps, detents, nubs, tapered portions, or other features that may reduce the cross-sectional profile of opening 52.

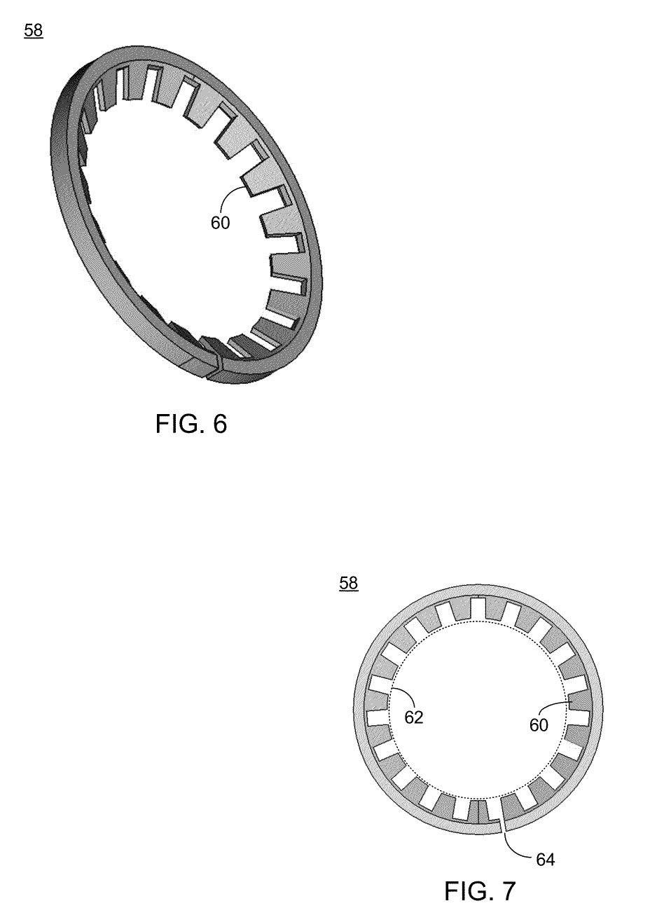

The connector may also include a conduit retainer disposed relative to the opening. For example, as shown in the illustrated embodiment, connector 12 may include two conduit retainers (e.g., conduit retainer 56 and conduit retainer 58) disposed relative to first and second ends of opening 52. The conduit retainer (e.g., one or more of conduit retainer 56 and conduit retainer 58) may include at least one engagement feature for mechanically engaging the conduit end portion to resist removal of the conduit end portion relative to the connector. With additional reference also to FIGS. 6 and 7, in an example embodiment, the conduit retainer (e.g., conduit retainer 58) may include a ring. Further, the at least one engagement feature may include a plurality of tabs (e.g., which may include tab 60). The plurality of tabs may extend radially inwardly from the ring and define a nominal opening having a cross-sectional profile less than the cross-sectional profile of the conduit end portion. For example, the nominal opening (e.g., nominal opening 62 depicted in dotted line) defined by the tabs (e.g., including tab 60) may have a cross-sectional profile less than the cross-sectional profile of an end portion of a conduit section to be coupled with connector 12. As such, the end portion of the conduit section may not be readily received through nominal opening 62 defined by the plurality of tabs.

At least a portion of the tabs may be elastically deformable upon insertion of the conduit end portion into the opening of the connector body for mechanically engaging the conduit end portion. For example, an end portion of a conduit section to be coupled with connector 12 may not be readily received through nominal opening 62 defined by the plurality of tabs. However, upon insertion (e.g., via an applied longitudinal force toward connector 12) of the conduit end portion into the opening of the connector body, at least a portion of the plurality of tabs may elastically deform. The elastic deformation of the at least a portion of the plurality of tabs may result in the opening defined by the plurality of tabs having a cross-sectional profile generally equal to the cross-sectional profile of the end portion of the conduit section. As such, the conduit section may be received through the opening defined by the plurality of tabs, and may be at least partially received in opening 52 defined by connector body 50. Further, the elastic deformation of the at least a portion of the plurality of tabs may result in a biasing force toward nominal opening 62. As such, at least a portion of the plurality of tabs may provide an inward force against a conduit end portion inserted into the opening defined by the plurality of tabs.

In an embodiment, at least a portion of the plurality of tabs may be angled relative to a longitudinal axis of opening 52 (and/or connector 12, generally) generally toward a longitudinal center of opening 52. That is, at least a portion of the plurality of tabs may be inwardly angled relative to opening 52. Based upon, at least in part, the angled configuration of the at least a portion of the plurality of tabs and the biasing force resulting from the elastic deformation of at least a portion of the plurality of tabs upon insertion of a conduit end portion, the retainer (e.g., retainer 56, 58) may resist removal of a conduit section relative to connector 12. For example, upon the application of a force tending to remove a conduit section relative to connector 12, the plurality of tabs (which may be inwardly angled generally in opposition to a removal force) may tend to dig into the exterior of a conduit end portion mechanically coupled with connector 12 to resist removal of the conduit end portion relative to connector 12.

The conduit retainer may include a ring having a radial split allowing the ring to expand outwardly upon insertion of the conduit end portion into the opening of the connector body. For example, as shown, e.g., in FIG. 7, retainer 58 may include a ring having radial split 64. In addition/as an alternative to elastic deformation of at least a portion of the plurality of tabs upon insertion of a conduit end portion through the opening defined by the plurality of tabs, the retainer 58 may expand outwardly (e.g., resulting in an increase in the circumference of retainer 58). The outward expansion of the ring may, at least in part, provide an increase in the opening defined by the plurality of tabs to have a cross-sectional profile generally equal to the cross-sectional profile of the conduit end portion. As such, in some embodiments, the outward expansion of the ring may facilitate the conduit end portion being at least partially received in opening 52 (e.g., via the opening defined by the plurality of tabs). In addition to facilitating receiving the conduit end portion, the expansion of the ring may also provide a biasing force against the conduit end portion (e.g. resulting from, at least in part, an elastic spring force resisting the expansion of the ring). The biasing force against the conduit end portion may, in some embodiments, assist in resisting removal of the conduit end portion relative to connector 12, in a generally similar manner as described above.

The conduit retainer may be configured to electrically couple the conduit end portion with the connector body when the conduit end portion is received in the opening of the connector body. For example, conduit retainer 56, 58 may include a metallic, or conductive member. In an embodiment, radial split 64 may facilitate electrically coupling the conduit end portion with connector body 50. For example, upon insertion of a conduit end portion through the opening defined by the plurality of tabs, retainer 58 may expand outwardly to engage one or more of connector body 50 and a collar (e.g., one or more of collars 66, 68). When retainer 58 expands outwardly and engages one or more of connector body 50 and/or a collar, retainer 58 may provide an electrical pathway between the conduit end portion and the connector body and/or a collar (which may be electrically coupled with connector body 58). In an embodiment, in which a conduit end portion may be coupled with each end of connector 12, the two conduit end portions coupled with connector 12 may be electrically coupled with each other, via connector 12. In one such embodiment, the electrical coupling of the two conduit end portions via connector 12 may allow the respective conduit sections to form a continuous ground (e.g., in a situation in which the conduit sections are themselves appropriately grounded and/or part of a grounding pathway).

As generally mentioned above, the connector may also include a collar (e.g., collars 66, 68). Collars 66, 68 may be releasably coupleable with the connector body to releasably retain the conduit retainer (e.g., conduit retainers 56, 58) relative to connector body 50. For example, as shown, conduit body 50 may include threaded features 70, 72, which may be releasably coupled with cooperating threaded features 74, 76 of collars 66, 68. As such, collars 66, 68 may be releasably coupled with connector body 52. As shown, conduit retainers 56, 58 may be sized so as to be captured between respective collars 66, 68 and connector body 52, when collars 66, 68 are coupled with connector body. As such, conduit retainers 56, 58 may be releasably retained relative to connector body 50. Accordingly, conduit retainers 56, 58 may be removed from connector body 50, for example, to allow for the removal of a conduit section coupled to connector 12, for the removal and/or replacement of a damaged conduit retainer, or the like. In some embodiments, the conduit retainer and/or the collars may be replaced with an undamaged before, or even after, the concrete slab is poured.

It will be appreciated that while the illustrated embodiment has been generally shown and described as including grab ring connector features associated with each end of the connector, other configurations may be implemented. For example, one end of the connector may be configured to be coupled with a conduit end portion using a set screw-type fastening, a compression-type fastening, or the like. Accordingly, in some embodiments, the connector may only include push-connector features associated with one end of the connector. In some embodiments, the threaded connection of the collars may allow one or the other of the connector body and the conduit retainers to be replaced separately of the other. Other embodiments may be equally utilized. Further, it will be appreciated that one, or both, ends of the connector may include a seal, such as an o-ring, a gasket, or the like, which may resist intrusion of water, concrete, and/or other debris or contaminants into the connector. As such, when the concrete slab is poured around the connector, the connector may resist intrusion of water and/or concrete into the connector.

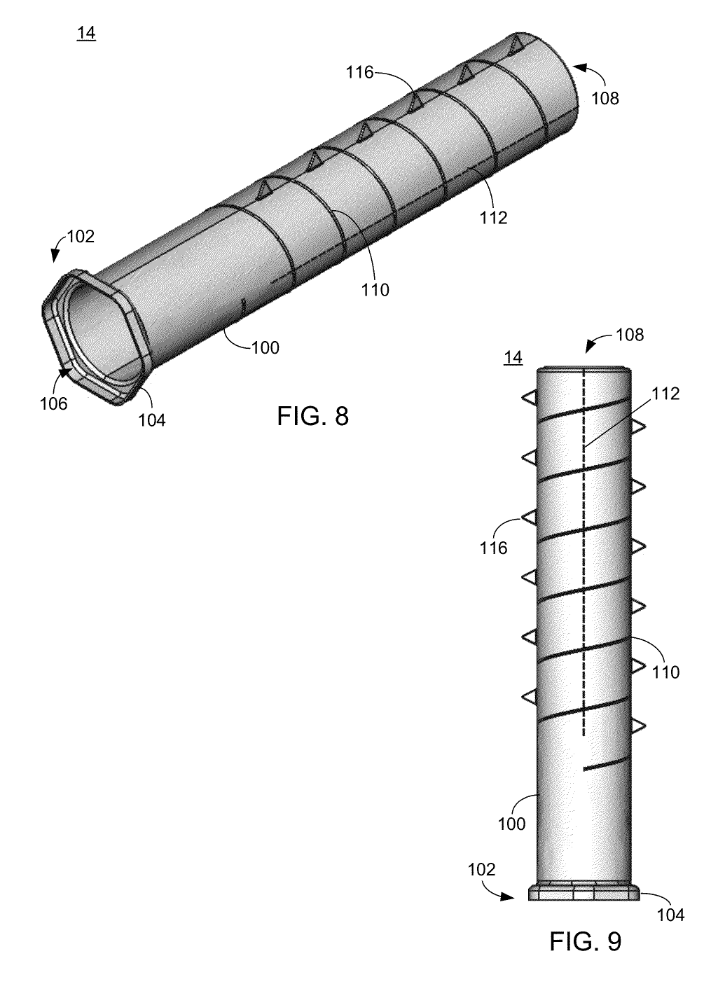

The conduit stub-up connection assembly may further include a conduit access form (e.g., conduit access form 14). Conduit access form 14 may be configured to be coupled relative to opening 52 of the connector body 50 and to extend longitudinally from connector 12. With additional reference to FIGS. 8 and 9, conduit access form 14 may include a generally tubular member (e.g. tubular body 100). In an embodiment, the tubular body 100 may include a sleeve of an intumescent material, e.g., which may include a fire resistant and/or fire rated material. In some embodiments, tubular body 100 may include, for example, a cardboard material, a plastic material, a foamed material, and/or another suitable material as will be understood based on the disclosure herein. While tubular body 100 is generally shown having a circular cross-sectional shape, it will be appreciated that other cross-sectional shapes may suitably be used, such as polyhedral, oval, irregularly shaped, etc.

Tubular body 100 may have a first end (e.g., end 102, generally) configured to be disposed at least partially around the connector 12. In some embodiments, first end 102 of the generally tubular member (e.g., tubular body 100) may releasably engage the connector with the generally tubular member. In the illustrated example embodiment, first end 102 of conduit access form 14 may include a flange (e.g., flange 104) defining a recess (e.g., recess 106, generally) configured to be disposed at least partially around the connector body. In the illustrated embodiment, recess 106 of flange 104 may be configured to be at least partially disposed around one of collar 66, 68. For example, recess 106 is shown having a generally hexagonal shape, corresponding to the general shape of collars 66, 68. In some embodiments, conduit access form 14 may include one or more of a snap-fit feature and a press-fit feature to coupled the conduit access form relative to the opening of the connector body.

As generally discussed above, conduit access form 14 may be coupled to connector 12, which may in turn be coupled to in-slab conduit 18 prior to pouring concrete slab 16. In some embodiments, conduit access form 14 may be removably coupleable with connector 12. As such, conduit access form 14 could be coupled with connector 12 prior to pouring the concrete of slab 16. Further, conduit access form 14 may extend longitudinally from connector 12 such that a distal end (e.g., end 108) of conduit access form extends above an intended top surface of concrete slab 16. When concrete slab 16 is poured, conduit access form 14, coupled with connector 12, may provide a chase, or access way, between top surface 22 of slab 16 and connector 12. Conduit access form 14 may have a cross-sectional profile larger than a cross-sectional profile of the conduit end portion (e.g., an end portion of above-slab conduit section 20). The larger cross-sectional profile of conduit access form 14 may, for example, allow an end portion of above-slab conduit section 20 to be at least partially received through the chase, or access way, created in slab 16 by conduit access form 14. In an embodiment, at least a portion of conduit access form 14 may remain embedded within slab 16 when above-slab conduit section 20 is coupled with connector 12. In one such embodiment, tubular body 100 may include an inside cross-sectional profile (e.g., a cross-sectional profile of an interior opening defined by tubular body 100) that is larger than the cross-sectional profile of the end portion of above-slab conduit section 20. In an embodiment, a substantial portion, and/or the entirety, of conduit access form may be removed from slab 16 when above-slab conduit section is coupled with connector 12. In one such embodiment, tubular body 100 may include an outside cross-sectional profile (e.g., the cross-sectional profile of the exterior of the tubular body) that is larger than the cross-sectional profile of the end portion of above-slab conduit section 20.

As generally described above, conduit access form 14 may be provided having a longitudinal dimension such that end 108 of conduit access form 14 may extend above top surface 22 of slab 16. Further, in an embodiment, after slab 16 has been poured (e.g., and at least partially cured or hardened), the longitudinal dimension of access form 14 may be adjusted to be generally flush with, or recessed below, top surface 22 of slab 16. In some embodiments, the longitudinal dimension of conduit access form 14 may be adjusted by cutting off a portion of conduit access form 14 extending above top surface 22 of slab 16 (e.g., by cutting conduit access form 14 generally at the level of top surface 22). In some embodiments, all, and/or at least a portion of, conduit access form may be removed from slab 16.

In some embodiments, conduit access form 14 may be configured to facilitate removal of at least a portion of tubular body 100 without the need for cutting tools. For example, tubular body 100 may include at least one region of mechanical weakness that may facilitate removal of at least a portion of tubular body. The at least one region of mechanical weakness may include, for example, a perforation line, a tear line (e.g., a line of localized thinning of the wall of tubular body, a partial cut line, etc), an embedded cutting feature, such as an embedded wire or string that may facilitate fracturing the wall of tubular body 100, or the like.

For example, and with continued reference to FIGS. 8 and 9, tubular body 100 may include one or more perforation lines. After the concrete slab has been poured around conduit stub-up connection assembly 10 (e.g., including conduit access form 14), the one or more perforation lines may facilitate the removal of at least a portion of tubular body 100 extending above the top surface of the concrete slab. The perforation line may include a generally helical perforation line (e.g., helical perforation line 110) on the generally tubular member (e.g. tubular body 100). In such a configuration, and with reference also to FIGS. 2 and 3, helical perforation line 110 may allow at least a portion of tubular body 100 to be removed by tearing tubular body 100 along helical perforation line 110 to “peel” tubular body 100 down to approximately the top surface of the concrete slab. In some embodiments, helical perforation line 110 may allow tubular body 100 to be torn, or peeled, down to approximately the level of connector 12, thereby substantially removing conduit access form from slab 16. In some embodiments, the perforation line may additionally/alternatively include a generally longitudinal perforation line (e.g., longitudinal perforation line 112). In one such embodiment, once tubular body 100 has been torn along helical perforation line 110 down to approximately the top surface of the concrete slab, the detached helical strip may be separated from the remainder of tubular body 100 along longitudinal perforation line 112. In some embodiments, conduit access form 14 may additionally/alternatively include one or more circumferential perforation lines on the generally tubular member. The one or more circumferential perforation lines may similarly facilitate removing at least a portion of tubular body 100, e.g., to thereby adjust the longitudinal dimension of conduit access form 14 to approximately the top surface of the concrete slab. In an embodiment, conduit access form 14 may include a tab, pull ring (e.g., pull ring 114 shown in FIG. 1), or other feature proximate distal end 108 that may facilitate initiating tearing tubular body 100 along the one or more perforation lines. For example, the tab, pull ring, or the like may allow an adequate grip to be obtained on a portion of tubular body 100 for initiating a tear along the one or more perforation lines. It will be appreciated that while, in FIGS. 2 and 3, conduit access form 14 is shown partially helically torn with above-slab conduit section 20 inserted there through, such illustration is intended for the purpose of explanation. In some embodiments, conduit access form 14 may be helically (or otherwise) torn or separated prior to the insertion of above-slab conduit section 20 there through.

In some embodiments, an exterior of conduit access form 14 may include one or more features that may facilitate mechanical bonding between tubular body 100 and the concrete of slab 16, which may subsequently poured around conduit stub up connection assembly 10. Such mechanical bonding may, for example, facilitate maintaining the positioning and placement of conduit access form 14 within concrete slab 16. For example, in the illustrated embodiment, conduit access form 14 may include a plurality of protrusions (e.g. protrusion 116) extending outwardly from tubular body 100. In addition/as an alternative to the protrusions, conduit access form may include circumferential, ribs, helical ribs, and/or other suitable features for facilitating mechanical body between tubular body 100 and the surrounding concrete slab. It will be appreciated that, for example in an embodiment in which conduit access form 14 may be substantially removed from slab 16, conduit access form 14 may be provided not including the protrusions.

Conduit stub-up connection assembly 10 may include a plug, or other similar feature, that may reduce and/or prevent the obstruction of the conduit chase or access-way provided by conduit access form 14. For example, once conduit stub-up connection assembly 10 has been coupled with in-slab conduit section 18, concrete slab 16 has been poured around conduit stub-up connection assembly 10, and conduit access form 14 has been torn away to approximately top surface 22 of slab 16, various other construction processes may take place before above-slab conduit section 20 is coupled with in-slab conduit section 18 via conduit stub-up connection assembly. During the various intervening construction processes it may be possible that debris may fall into the chase or access-way created by conduit access form 14. Such debris may impede the insertion and connection of above-slab conduit section 20 with conduit stub-up connection assembly 10 and/or impede the routing of electrical conductors through the conduit raceway. In order to reduce and/or prevent the accumulation of debris within, and/or facilitate the removal of debris from the chase or access-way provided by conduit access form 14, stub-up connection assembly 10 may include a plug assembly that may be removably disposed within the generally tubular member. The plug assembly may at least partially block the opening of the connector body.

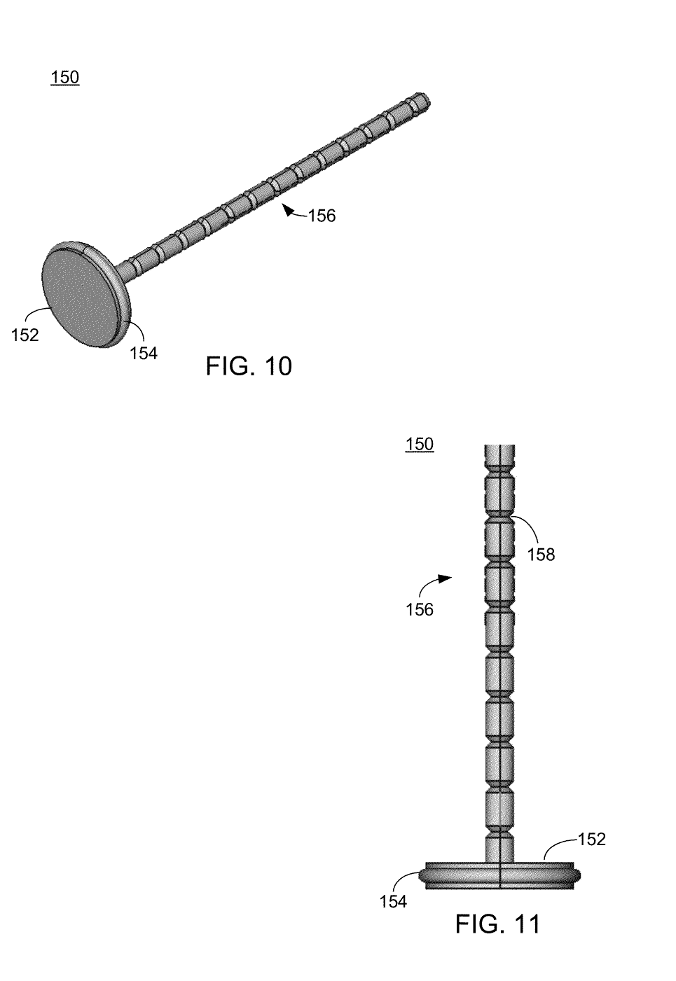

For example, and referring also to FIGS. 10 and 11, an illustrative example plug (e.g., plug 150) is shown, which may reduce and/or prevent the accumulation of debris, and/or facilitate the removal of debris from within the chase or access-way provided by conduit access form 14. In the illustrated embodiment, plug 150 may generally include disk 152, or other obstructing feature. Disk 152 may have a cross-sectional profile sized and shaped to be disposed within the interior passage defined by conduit access form 14, and may be generally sized to be completely and/or substantially cover the opening in connector 12, e.g., to minimize and/or prevent debris from accumulating within connector 12. In some embodiment, disk 152 may include o-ring 154, or other feature that may engage the inner wall of tubular body 100. O-ring 154 may facilitate maintaining plug 150 in position relative to conduit access form 14. Additionally/alternatively, o-ring 154 may engage the inner wall of tubular body 100 and/or opening 52 of connector 12 to further reduce and/or prevent the accumulation of debris within connector 12.

Plug 150 may be removed from conduit access form 14 prior to the insertion and connection of above-slab conduit section 20. In an embodiment, plug 150 may include post 156, a pull-cord, or other feature that may facilitate the removal of disk 152 from within conduit access form 14. In the illustrated embodiment, post 156 may be segmented, by including a plurality of break lines (e.g., break line 158). The break lines may include regions of localized weakening (e.g., through a reduced cross-section region, or other form of weakening). The regions of localized weakening may allow post 156 to be broken to reduce the length of post 156, e.g., to be at a level generally flush to, or at least partially below, the top surface of the slab. As such, both plug 150 and conduit access form 14 may be reduced in length to be generally at, or below, the level of the top surface of the slab. In an embodiment, the removal of plug 150 from within conduit access form 14 may allow above-slab conduit section 20 to be inserted through the chase or access-way provided by conduit access form 14, and may remove any debris that may have accumulated within the chase or access-way provided by conduit access form 14.

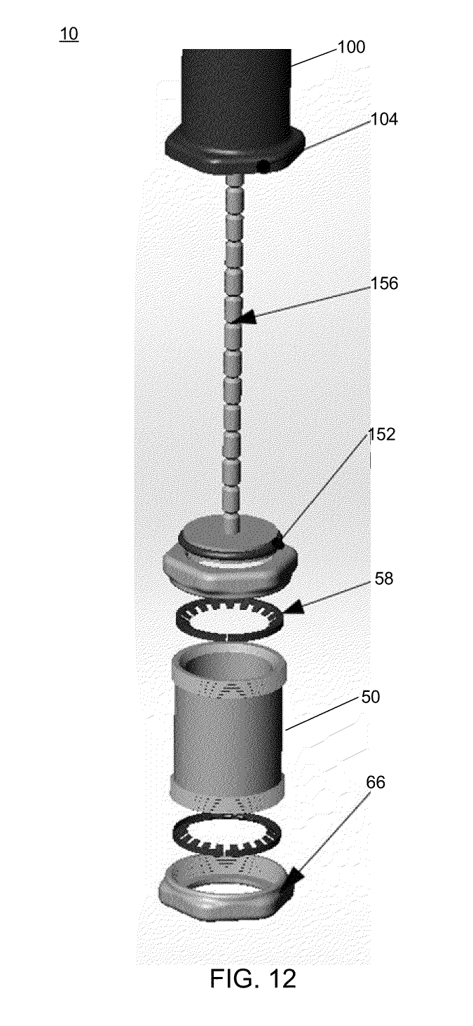

With reference to FIG. 12, and exploded view of the illustrated example conduit stub-up connection assembly is generally shown. In the illustrated embodiment, a grab ring connector may include conduit retainers (e.g., conduit retainer 58), which may be removably coupled with a connector body 52 by removable collars (e.g., collar 66). Conduit sections may be pushed into the grab ring connector, which may mechanically coupled the conduit section to resist removal of the conduit section relative to the connector. In the illustrated embodiment, the connector may include grab ring connector features (e.g., conduit retainers removably coupled with the connector body using removable collars) associated with each end of the connector. As such, two conduit sections may be coupled to one another via each end of the connector. In the illustrated embodiment, the conduit stub-up connection assembly may also include a conduit access form including a generally tubular body 100 and flange 104 configured for coupling the conduit access form with the connector. The generally tubular body 100 may be configured to receive at least a portion of a conduit section there through, to permit the conduit section to engage the connector through at least a portion of the conduit access form. Additionally, disk 152 may be configured to be removably disposed within at least a portion of the conduit access form. Disk 152 may prevent and/or reduce the obstruction of the connector, and of a conduit raceway including the connector, by debris or the like. Disk 152 may be removably from the conduit access form, e.g., using post 156, which may be used to pull disk 152 from the conduit access form. It will be appreciated that the example conduit stub-up connection assembly may be susceptible to various alterations and modifications, which are contemplated by the present disclosure.

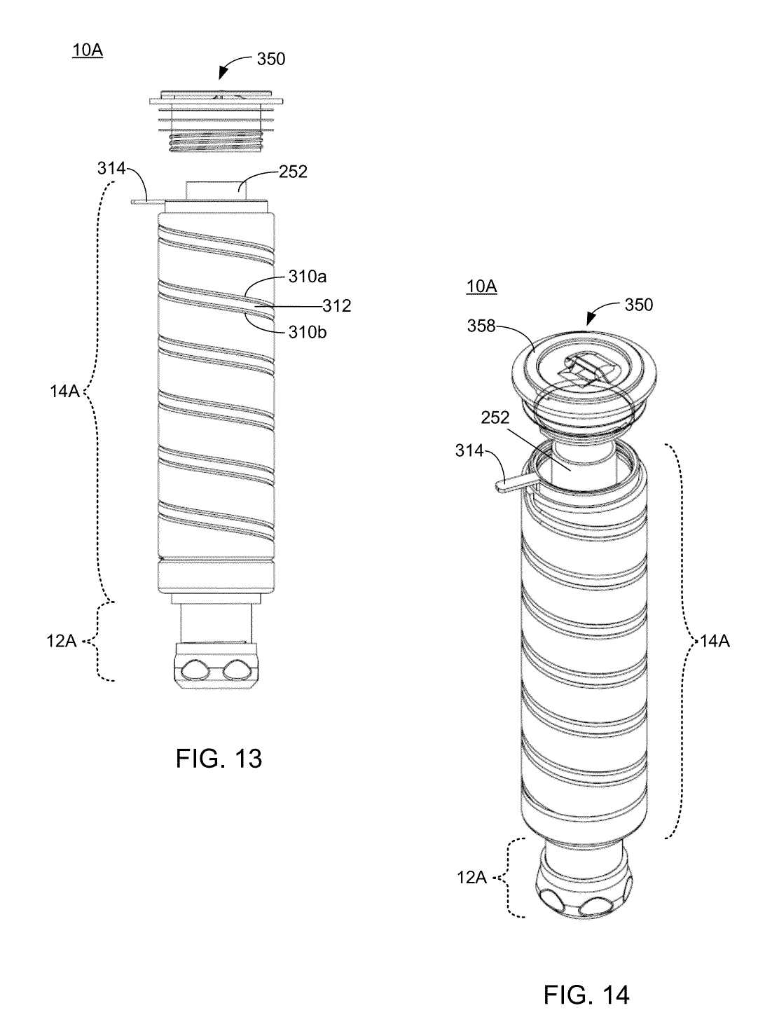

Referring also to FIGS. 13 through 20, another illustrative example embodiment of a conduit stub-up connection assembly (e.g., conduit stub-up connection assembly 10A) is shown. Similar to the previously described embodiment, conduit stub-up connection assembly 10A may generally include a connector (e.g. connector 12A) and a conduit access form (e.g., conduit access form 14A). Conduit stub-up connection assembly 10A may be utilized for providing conduit raceways in which at least a portion of the conduit raceway is embedded in a concrete structure, such as a concrete slab, concrete wall, or the like (e.g., which may all be contemplated by the use of the term “slab”). For example, connector 12A may allow an above-slab conduit section to be coupled with an in-slab conduit section, which may be embedded in a concrete slab. Further, conduit access form 14A may provide a conduit access-way within at least a portion of the concrete slab, as by excluding concrete from the conduit access-way during at least a portion of the pouring and/or setting of the concrete slab.

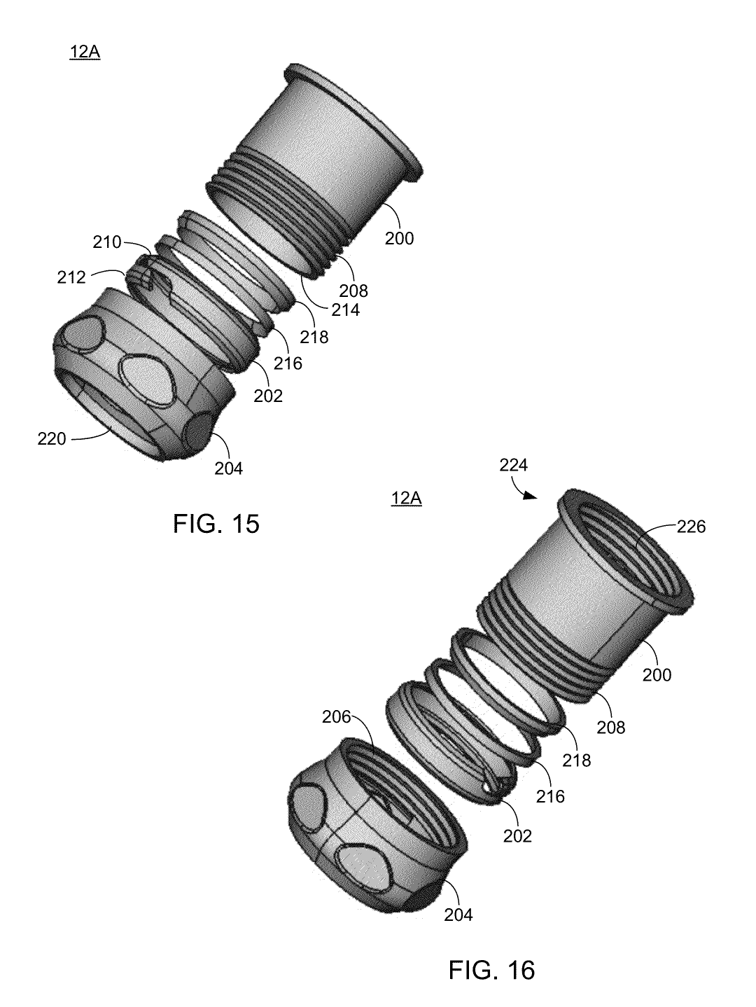

Referring also to FIGS. 15 and 16, an illustrative example embodiment of conduit connector 12A is shown. Conduit connector 12A may generally include connector body 200. Consistent with the illustrated example embodiment, connector body 200 may include a generally tubular body. In an embodiment, generally tubular connector body 200 may define an interior opening extending longitudinally through connector body 200. The interior opening may be sized to receive at least a portion of a conduit section (e.g., one or more of an in-slab conduit section and an above-slab conduit section). In some embodiments, connector body 200 may include one or more conduit stops within the interior opening. As generally described above, the one or more conduit stops may limit the extent to which an end portion of a conduit section may be inserted into the opening of connector body 200.

Connector 12A may include a conduit retainer, which may be disposed relative to a first end of connector body 200. Further, the conduit retainer may include at least one engagement feature for mechanically engaging a first conduit end portion (such as an end portion of an in-slab conduit section) to resist removal of the first conduit end portion relative to connector 12A. In the illustrated example, the conduit retainer may include a compression ring (e.g., compression ring 202) and a collar (e.g., collar 204) threadably engageable with the first end of connector body 200. For example, collar 204 may threadably engage the first end of connector body 200 via cooperating threads 206, 208 of collar 204 and connector body 200, respectively. Consistent with the illustrated example embodiment, tightening collar 204 relative to connector body 200 may reduce a cross-sectional profile of compression ring 202 to engage the first conduit end portion.

For example, as shown, compression ring 202 may include a split ring having at least one beveled surface (e.g., beveled surfaces 210, 212). The at least one beveled surface (e.g., beveled surfaces 210, 212) may be configured to engage a cooperating beveled surface associated with one or more of the connector body and the collar, for example, beveled surface 214 on the interior inner edge of connector body 200 and a beveled surface on the inter surface of collar 206 (not shown). Additionally/alternatively, one or more of beveled surfaces 210, 212 of compression ring 202 may engage complementary beveled surfaces of one or more supporting rings (e.g., supporting rings 216, 218). As used herein, any of the cooperating beveled surfaces of compression ring 202, collar 204, connector body 200, and/or supporting rings 216, 218 may include angled surfaces, rounded surfaces, chamfered edges, or the like. Consistent with the foregoing, engagement between at least one beveled surface of the compression ring and the cooperating beveled surface (e.g., of the connector body, the collar, and/or one or both of the supporting rings) may reduce the cross-sectional profile of the compression ring. For example, tightening collar 204 relative to connector body 200 (e.g., threading collar 204 further onto connector body 200) may force one or more of the beveled surfaces (e.g., beveled surfaces 210, 212) against one or more of the cooperating beveled surfaces (e.g., beveled surface 214 of connector body and/or one or more beveled surface of collar 204 and/or supporting rings 216, 218) squeeze compression ring 202 to urge compression ring 202 to a smaller diameter. In some embodiments, reducing the cross-sectional profile (e.g., the diameter) of compression ring 202 may be facilitated, at least in part, based upon the split-ring configuration of compression ring 202, which may allow deformation of compression ring 202 toward a smaller diameter.

In an embodiment, an end portion of a conduit section (such as the in-slab conduit section) may be at least partially received in the opening of connector body 200. Further, compression ring 202 and collar 204, as well as supporting rings 216, 218 may be disposed around the conduit section. In such a configuration, collar 204 may threadably engage connector body 200 with compression ring 202, and supporting rings 216, 218 captured between distal rim 220 of collar 204 and first end 222 of connector body 200. Tightening collar 204 relative to connector body 200 may cause the cooperating beveled surfaces of compression ring 202 to engage one or more of connector body 200, collar 204, and supporting rings 216, 218, and deforming (elastically and/or plastically) compression ring 202 toward a smaller inside diameter. Deforming compression ring 202 toward a smaller inside diameter may cause compression ring 202 to engage the conduit section and create sufficient mechanical forces between compression ring 202 and the conduit section such that the conduit section may resist sliding relative to compression ring 202. Further, compression ring 202 may be captured between collar 204 and connector body. As such, the conduit section may also resist sliding relative to connector 12A. The conduit section may, therefore, resist separation from connector 12A. Further, the engagement between the conduit section, compression ring 202, and one or more of collar 204 and connector body 200 may provide (when each component includes a conductive material) electrical coupling between the conduit section and connector 12A. One or more of supporting rings 216, 218 may include a plastic material, e.g., which may also compress against the conduit section (for example, by virtue of one or more cooperating beveled surfaces). In an embodiment, the compression of a plastic supporting ring against the conduit section and against one or more of connector body 200 and collar 204 (directly and/or via one or more additional components) may provide a seal between the conduit section and connector 12A. The seal may, for example, resist water and/or contaminant (e.g., dust, dirt, concrete, etc.) intrusion.

The connector may also include a threaded feature associated with a second end of the connector body. For example, as shown, second end 224 of connector body 200 may include interior threads 226 on the inner surface of the opening extending through connector body 200. The threaded feature (e.g., interior threads 226) may be configured for threadably engaging a cooperating threaded feature associated with a second conduit end portion for releasably engaging the second conduit end portion relative to the connector. In an embodiment, the cooperating threaded feature associated with the second conduit end portion may include cooperating threads formed on the second conduit end portion. For example, the second conduit end portion may include an exteriorly threaded surface which may be configured to threadably engage interior threads 226. As such, the second conduit end portion may be threadably coupled with connector 12A.

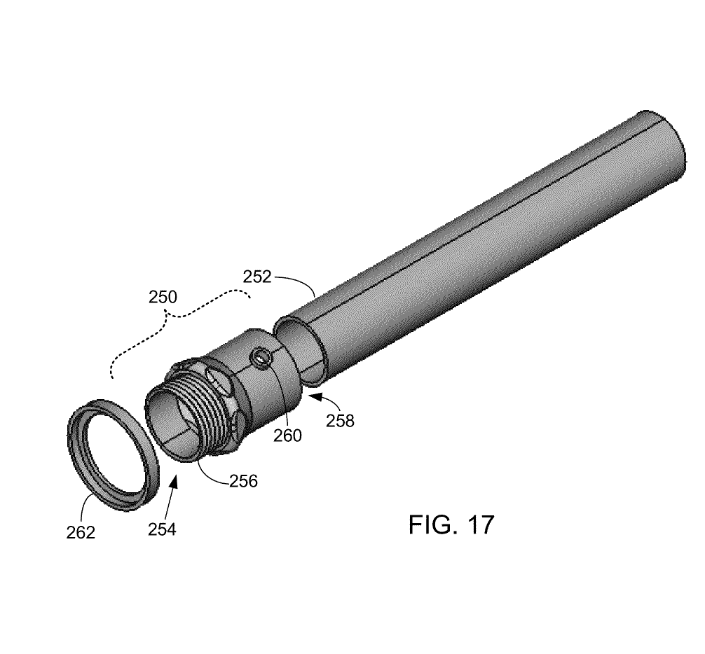

Referring also to FIG. 17, in an example embodiment, the cooperating threaded feature associated with the second conduit end portion may include a thread converter (e.g., thread converter 250). In an embodiment, thread converter 250 may generally be configured to be coupled with a conduit section (e.g., second conduit end portion 252) to allow the second conduit section to be threadably coupled with a cooperating threaded feature. For example, as shown in the illustrated example embodiment thread converter 250 may include first end 254 including the cooperating threaded feature 256 (e.g., which may include an exteriorly threaded end portion of thread converter 250). Thread converter 250 may also include second end 258 including an opening configured for receiving second conduit end portion 252. Thread converter 250 may also include a retention feature for retaining the second conduit end portion relative to the thread converter. For example, in the illustrated embodiment thread converter 250 may include set screw 260, which may be tightened to engage second conduit end portion 252, and resist separation of thread converter 250 and second conduit end portion 252. Consistent with the illustrated embodiment, second conduit end portion 252 may be releasably threadably coupled to connector 12A via thread converter 250, which may include cooperating threaded feature 256 configured to threadably engage interior threads 226 of connector 12A. In an embodiment, seal 262 (such as a rubber gasket, o-ring, washer, or the like) may be provided, which may create a seal between connector 12A and thread converter 250 when connector 12A and thread converter are threadably coupled with one another. Seal 262 may resist water, concrete, and/or other contaminant intrusion between connector 12A and thread converter 250. It will be appreciated that which connector 12A is shown including interior threads, and the conduit section and/or thread converter 250 is shown including exterior threads, other configurations may be equally utilized. For example, connector 12A may include exterior threads and the conduit section and/or thread converter may include interior threads.

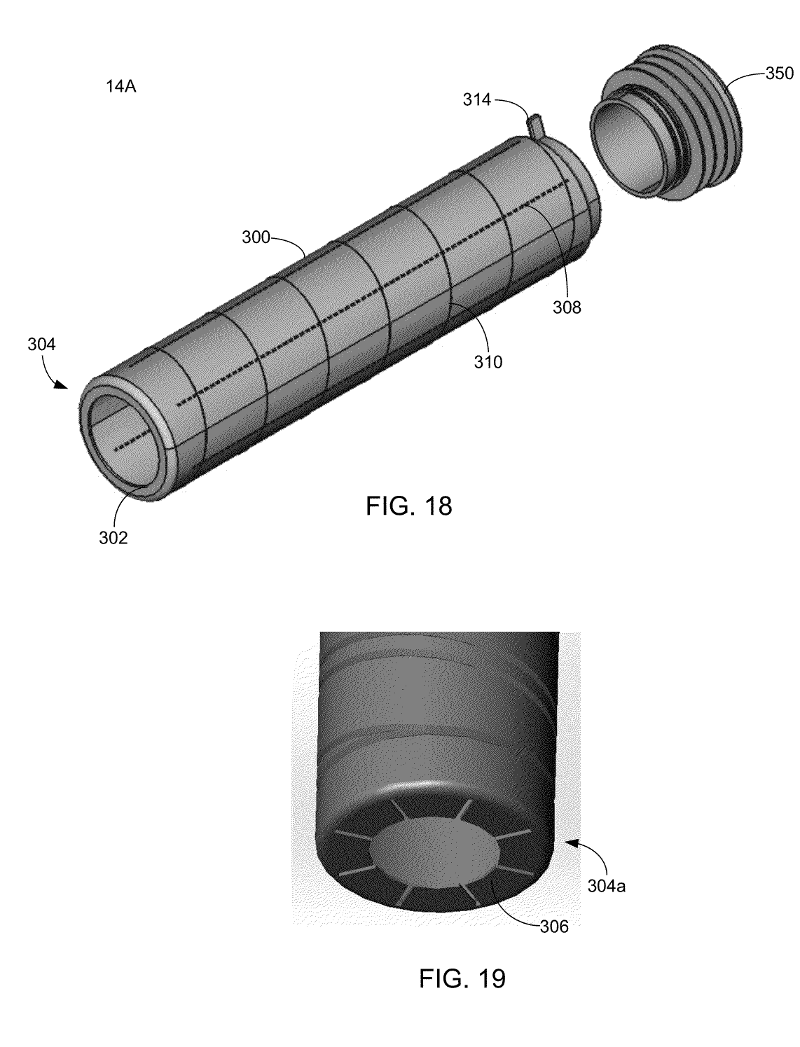

In a generally similar manner as the previously described embodiments, the conduit stub-up connection assembly may also include a conduit access form (e.g., conduit access form 14A). Conduit access form 14A may be configured to be coupled relative to the second end of connector body 12A and extend longitudinally from the connector. For example, and referring also to FIG. 18, conduit access form 14A may include a generally tubular body 300. Further, conduit access form 14A may have a cross-sectional profile larger than a cross-sectional profile of the second conduit end portion. For example, generally tubular body 300 may include an inside diameter that is larger than an outside diameter of a conduit section for which the conduit stub-up connection assembly is intended to be used. In this regard, different conduit stub-up connection assemblies may be sized for use with different sizes of conduit. In one particular embodiment, tubular body 300 may include an inside diameter that is larger than an outside diameter of thread converter 250. As such, thread converter 250 and second conduit end portion 252 may be at least partially disposed through, and/or within, tubular body 300.

In an embodiment, conduit access form 14A may be configured to be coupled relative to connector 12A by engaging one or more of the second conduit section and/or thread converter 250. For example, in the illustrative embodiment of FIG. 18, conduit access form 14A may include lip 302 adjacent first end 304 of tubular body 300. In an embodiment, lip 302 may define an inside diameter that is generally equal to an outside diameter of second conduit end portion 252 and/or threaded feature 256 of thread converter 250. In such an embodiment, at least a portion of second conduit end portion and/or threaded feature 256 may extend through the inside diameter defined by lip 302, but may be generally axially aligned with second conduit end portion 252 and/or thread converter 250. Referring also to FIG. 19, in an example embodiment, conduit access form 14A may include inward tabs (e.g., tab 306) adjacent first end 304a of conduit access form 14A. Tabs 306 may provide a generally segmented lip, e.g., which may engage one or more of second conduit end portion and/or threaded feature, in a generally similar manner as lip 302.

In one embodiment, tubular body 300 of conduit access form 14A may have an inside diameter that is greater than an outside diameter of thread converter 250, such that thread converter 250, including second conduit end portion 252, may be at least partially disposed within tubular body 300. As shown in FIGS. 13 and 14, second conduit end portion 252 may be coupled with thread converter 250, and may be inserted at least partially through tubular body 300. Further, thread converter 250 may be threadably engaged with connector 12A. In an embodiment, seal 262 may be disposed between thread converter 250 and connector 12A. For example, second conduit end portion 252 and thread converter 250 may be at least partially received within conduit access form 14A such that threads 256 of thread converter 250 may protrude from the end of conduit access form 14A. Seal 262 may be placed around threads 256, and threads 256 may be engaged with threaded feature 226 of connector 12A. In such an embodiment, seal 262 may resist intrusion of water, concrete, and/or contaminants contaminants into connector 12A and/or an interior of tubular body 300. Additionally, lip 302 and/or tabs 306 may be at least partially disposed between thread converter 250 and connector 12A, which may facilitate retained relative to the second end of connector 12A.

Conduit access form 14A may include one or more lines of mechanical weakness, which may facilitate removal of at least a portion of tubular body 300. For example, conduit access form 14A may include at least one of a longitudinal perforation line (e.g., longitudinal perforation line 308), a helical perforation line (e.g., helical perforation line 310), and a circumferential perforation line facilitating removal of at least a portion of the generally tubular member. Referring to FIGS. 13 and 14, in one illustrative example embodiment, conduit access form 14A may include tear-out strip 312 defined by generally parallel helical tear lines (e.g., tear lines 310a, 310b, which may include lines of localized thinning, perforation, or other mechanical weakness). In an embodiment, conduit access form 14A may further include tear tab 314, e.g., which may provide a grip surface that may provide adequate grip to initiate a tear along one or more lines of mechanical weakness (e.g., tear line 308, 310, etc.). In an example embodiment in which conduit access form 14A may be substantially and/or entirely removed from the slab after the slab has at least partially hardened, tear-out strip 312 may facilitate the removal of conduit access form 14A. For example, tear-out strip 312 may provide the removal of a strip of material from conduit access form 14A, which may facilitate collapsing and/or extracting the remainder of conduit access form 14A from the opening defined in the concrete slab.

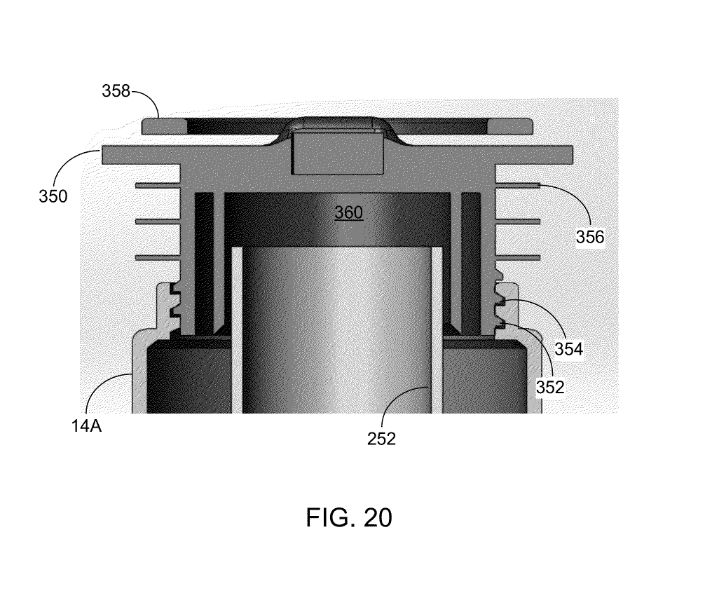

Referring also to FIG. 20, stub-up connection assembly 10A may also include a plug (e.g., plug 350). Plug 350 may include a first engagement feature (e.g., engagement feature 352) configured to releasably retain plug 350 relative to conduit access form 14A. Engagement feature 352 may include, for example, circumferentially extending flanges, fins, threads, or the like, that may engage cooperating features (e.g., grooves 354) of conduit access form 14A. In some embodiments, engagement features may not engage cooperating features, but may frictionally engage conduit access form 14A and/or a conduit section at least partially disposed within conduit access form 14A. various additional and/or alternative engagement features for retaining the plug relative to the conduit access form may equally be utilized. In an embodiment, plug 350 may engage conduit access form 14A to prevent and/or reduce intrusion of concrete into the interior of conduit access form 14A, e.g., during the pouring of the concrete slab. Plug 350 may also prevent and/or reduce the intrusion of other debris of foreign objects into the interior of conduit access form 14A.

Plug 350 may also include a second engagement feature (e.g., engagement features 356) configured to releasably retain the plug relative to a conduit access-way provided in a concrete body by the conduit access form. For example, when a concrete slab is poured around conduit access form 14A, conduit access form may create a conduit access-way within the concrete slab. At least a portion of conduit access form 14A may be removed from the concrete slab leaving a conduit access-way. Engagement features 356 of plug 350 may engage the side walls defining the conduit access-way, thereby removably retaining plug 350 relative to the concrete slab/the conduit access way defined within the concrete slab. In an embodiment, plug 350 may resist the intrusion of debris (such as dust, dirt, or other foreign materials or objects) into the conduit access-way defined in the concrete slab. In an embodiment, plug 350 may include pull-ring 358, which may facilitate the removal of plug 350 from the conduit access-way defined in the concrete slab. In an embodiment, plug 350 may be formed from a plastic material. In such an embodiment, pull-ring 358 may include a plastic ring (which may be integral with plug 350 and/or another component coupled to plug 350), which may lie generally flush with a top surface of plug 350, and may be bent upwardly from the top surface to allow gripping of pull-ring 358. Various additional and/or alternative features may be utilized to facilitate removal of plug 350 from a conduit access-way formed in a concrete slab. For example, plug 350 may include an indentation and/or slot which may facilitate prying plug 350 from the conduit access-way using a tool, such as a screw driver, or the like.

Additionally, and as shown in the example embodiment in FIG. 20, the interior of plug 350 may generally define a recess (e.g., recess 360) that may receive at least a portion of second conduit end portion 252. In one such embodiment, receiving at least a portion of second conduit end portion 252 at least partially within recess 360 may facilitate locating second conduit end portion 252 within conduit access form 14A. Further, in an example embodiment, receiving at least a portion of second conduit end portion 252 at least partially within recess 360 may also aid in stabilizing second conduit end portion 252 and conduit access form 14A relative to one another, e.g., during the pouring of the concrete slab, etc.

While various embodiments of a conduit stub-up connection assembly have been described, it will be appreciate that the various aspects of the embodiments may be susceptible to combination with one another. For example, the compression connection of connector 12A may be substituted for the grab ring connection of connector 12. Similarly, conduit access form 14 may be substituted for conduit access form 14A. Further various embodiments of conduit access form 14, 14A, as well as of other components, have been illustrated and described. It will be appreciate that such various components may be susceptible to substitution and combination within the other various described embodiments. Various other features and/or attributes of the various embodiments, may similarly be implemented in connection with features and/or attributes of others of the various embodiments.

As generally discussed above, an in-slab conduit stub-up connection may be provided including coupling a first end of a conduit connector to a in-slab conduit. A conduit access form may be coupled relative to a second end of the conduit connector. The conduit access form may extend above an intended slab grade. A concrete slab may be poured surrounding at least a portion of the in-slab conduit and the conduit connector. The conduit access form may extend above the poured slab. Further at least a portion of the conduit access form extending above the slab may be removed. In an example embodiment, removing at least a portion of the conduit access form may include tearing the conduit access form along one or more of a longitudinal, a helical, and a circumferential line of mechanical weakness included in the conduit access form. In an embodiment, removing at least a portion of the conduit access form may include removing at least a portion of the conduit access form down to a level generally at the surface of the slab. In an embodiment, removing at least a portion of the conduit access form may include removing substantially all of the conduit access form. Additionally, at least a portion of an above-slab conduit section may be inserted through an opening defined in the slab by the conduit access form. The at least a portion of the above-slab conduit may be coupled with the conduit connector. In an embodiment, the at least a portion of the above-slab conduit may be inserted into a second end of a grab ring conduit connector to engage the at least a portion of the above-slab conduit with the grab ring conduit connector to resist removal of the at least a portion of the above-slab conduit relative to the grab ring conduit connector. In an embodiment, the at least a portion of the above-slab conduit may include a threaded feature. The threaded feature may be threadably engaged with a cooperating threaded feature of the conduit connector. In an embodiment, the threaded feature of the above-slab conduit may include a thread converter coupled with the above-slab conduit.

For example, a conduit access form, which may include a sleeve, tube, or frangible body may be indexed to, and placed on and/or over a conduit connector, which may be coupled to a conduit section that is intended to be embedded in a concrete slab, or the like. The conduit connector may be coupled to the conduit section that is intended to be embedded in the concrete slab using a grab ring connector, a compression connector, a set-screw connector, or other suitable connector. The conduit access form may by sized and positioned to extend upwardly from the connector to a height that may be above the intended final grade or elevation of the concrete slab that is to be poured. In an illustrative example, the conduit access form may be about 6 inches tall, to accept any generally standard variations in concrete slab thickness. However, the height of the conduit access form may vary depending, for example, on an intended thickness of the concrete slab and a general depth of the grab ring connector within the intended concrete slab. As generally mentioned, the conduit access form may be of sufficient height so that it may extend above the surface of the concrete slab once poured. In an embodiment, the conduit access form may be coupled to the conduit connector. In an embodiment, the conduit access form may be coupled to a piece of conduit that may be threadably coupled to the conduit connector.

With the conduit access form positioned relative to the conduit connector, the concrete slab may be poured, thereby burying and/or embedding the in-slab conduit section, the conduit connector, and at least a portion of the conduit access form within the concrete slab. As described above, the conduit access form may be provided having a height such that at least a portion of the conduit access form may extend above the finished height or elevation of the poured concrete slab. In an embodiment, after the concrete slab has been poured (e.g., which may include after the concrete slab has set), the sleeve, tube, or the like of the conduit access form may be cut down to approximately the surface of the concrete slab. In an embodiment, after the concrete slab has been poured (e.g., which may include after the concrete slab has set), the sleeve, tube, or the like of the conduit access form may be removed to a level below the surface of the concrete slab. In an embodiment, conduit access form may be removed to a level of approximately the height of the conduit connector within the concrete slab.

In some embodiments, the conduit access form may be cut down to approximately the surface of the concrete slab, below the surface of the concrete slab, and/or to approximately the level of the conduit connector within the concrete slab using conventional cutting tools. In some embodiments, the conduit access form may include one or more sets of perforations or tear-lines (e.g., lines of weakening of the material of the sleeve, tube, etc.), which may allow the conduit access form to be reduced in height to approximately to level of the slab, the a height below the surface of the concrete slab, and/or to approximately the level of the conduit connector within the concrete slab, e.g., by tearing. For example, the conduit access form may include one or more of vertical perforations and/or tear lines that may generally extend along the axial direction of the conduit access form. Additionally/alternatively the conduit access form may include one or more spaced apart circumferential perforations and/or tear lines and/or one or more generally helical perforations and/or tear lines. As such, the conduit access form may be torn along the one or more perforations and/or tear lines such that at least a portion of the conduit access form extending above the grade level of the concrete slab may be disconnected from at least a portion of the conduit access form embedded within the concrete slab. A greater extend of the conduit access form may be removed from within the concrete slab using the perforations and/or tear lines, such as to a height below the surface of the concrete slab, and/or to approximately the level of the conduit connector within the concrete slab

Disconnecting the portion of the conduit access form above the slab elevation (including disconnection the portion of the conduit access form to a height below the surface of the slab and/or to a general height of the conduit connector within the slab) may provide an unobstructed walk path on the newly created slab. Additionally, the conduit access form below the grade level of the concrete slab (whether a portion of the conduit access form remains embedded in the concrete or whether substantially all of the conduit access form is removed form the concrete slab) may provide an opening, or hole, in the concrete slab from the surface of the slab down to the top of the conduit connector. For example, the conduit access form may provide a void in the slab that is not filled with concrete when the concrete slab was poured. In an embodiment, at the bottom of the conduit access form there may be plug or a raceway protector. The plug or raceway protector may remain in place to keep foreign objects or debris out of the raceway until such time that the vertical conduit extension (e.g., an above-slab conduit section) is inserted. In an embodiment, the plug or raceway protector may be disposed in the opening or hole in the concrete slab generally adjacent to the surface of the concrete slab, which may keep foreign objects or debris out of the raceway until such time that the vertical conduit extension is inserted. Prior to insertion of the above-slab conduit section, the plug or raceway protector may be removed to allow future electrical wires to be pulled in the raceway. In some embodiments, a cap, plug, or similar device may be at least partially inserted into the top of the sleeve and/or conduit access-way created in the concrete slab by the conduit access form (e.g., at the grade of the concrete slab) to prevent the introduction of debris or foreign material into the sleeve prior to the insertion of the additional piece of conduit. In some embodiments, the cap/plug may also prevent someone from tripping on an opening in the slab (e.g., which may result from the sleeved opening in the concrete). For example, OSHA may require any hole in a slab over a 2″ diameter to have a hole cover put over it. In some circumstances a hole over 2″ may be created in the context of the present disclosure, and it may be desirable to protect any hole that may be created.

As described above, after the concrete slab has been poured, the conduit access form may provide a hole in the slab (e.g., via the inside diameter of the sleeve if a portion of the sleeve remains embedded in the slab and/or via the outside diameter of the sleeve if substantially all of the sleeve is removed from the slab) extending down to the conduit connector, as described above. The new piece of conduit (e.g., the above-slab conduit section, which may provide the vertical conduit run extending from the slab) may be inserted into the hole in the concrete slab and coupled with the conduit connector. In an embodiment, the conduit connector may include a grab ring connector. In such an embodiment, coupling the new piece of conduit with the conduit connector may include pushing the new piece of conduit into the conduit connector. Pushing the above-slab conduit section into the grab ring connector may cause the conduit retainer ring to bite into the conduit to prevent it from being pulled out of the connector. In some embodiments, pushing the above-slab conduit section into the connector may also causes the conduit retainer ring to expand and engage the connector body. In addition to retaining the conduit section relative to the connector, the conduit retainer ring biting into the conduit section and engaging the connector body may provide a positive electrical connection between the conduit section and the connector body, which may be electrically coupled to the in-slab conduit section. This electrical connection may provide a continuous ground between the above-slab conduit section and the in-slab conduit section.

In an embodiment, the conduit connector may include a threaded connector portion. In such an embodiment, the new piece of conduit may included a threaded feature that may be configured to threadably engage the threaded connector portion. In an embodiment, the end portion of the above-slab conduit may have threads formed on a portion of the conduit that are configured to threadably engage the threaded connector portion. In an embodiment, the above-slab conduit may include a section of conduit coupled to a thread converter. The thread converter may include a threaded feature configured to threadably engage the threaded connector portion. The new piece of conduit, included in the threaded feature, may be inserted into the hold provided by the conduit access form, and the threaded feature may be threadably engaged with the threaded connector portion. In an embodiment, the new piece of conduit may include a relatively short piece of conduit (e.g., which may extent a few inches to a few feet above the concrete slab when threadably engaged with the threaded connector). Subsequent sections of conduit may be coupled to the new, relatively short, piece of conduit using conventional conduit connectors. As with the push on connector, the threaded engagement between the new piece of conduit and the conduit connector may electrically coupled the new piece of conduit with the conduit connector to provide a continuous ground. Further, a grab ring connector feature, a compression connector feature, and/or another type of connector feature that may couple the conduit connector with the in-slab conduit section may similarly electrically coupled the conduit connector with the in-slab conduit section. As such, the conduit raceway, including the in-slab conduit section, the conduit connector, and the above-slab conduit section may provide a continuous ground.

In some embodiments, a grab ring connector and/or a compression connector, as generally described above, may be utilized for connecting pieces of conduit in circumstances in addition to connecting conduit below the surface of a concrete slab. For example, as described the grab ring connector and/or the compression connector may not only physically couple pieces of conduit so that the resist separation, the conduit connector may further electrically couple pieces of conduit. As such, conduit connectors as described herein may be utilized, for example, for connecting electrical raceways in applications such as in wall (e.g., framed, drywall, and/or masonry) raceways, in ceiling raceways, exposed raceways, and/or other applications. In some embodiments, conduit connectors may consistent with the present disclosure be used as an alternative to conventional conduit connectors. In other embodiments, threaded couplings may be used in connection with grab ring connectors and/or compression connectors (as described above), e.g., to allow damaged connectors and/or grab rings and/or compression rings to be replaced, dismantling raceways after completion (e.g., to allow relocation or reworking of the raceway prior to wire being pulled through the raceway). Various other implementations will be realized.

While particular embodiments have been illustrated and described, such embodiments have been provided for the purpose of example and explanation, and should not be construed as limiting the present disclosure. Various modifications and variations will be apparent to one having skill in the art. All such modifications and variations are considered to be within the scope of the present disclosure.

What is claimed is:

1. A stub-up connection assembly comprising:
a connector including a connector body defining an opening for receiving a conduit end portion, and a conduit retainer disposed relative to the opening and including at least one engagement feature for mechanically engaging the conduit end portion to resist removal of the conduit end portion relative to the connector; and
a conduit access form configured to be coupled relative to the opening of the connector body and extending longitudinally from the connector, the conduit access form having a cross-sectional profile larger than a cross-sectional profile of the conduit end portion.

2. The stub-up connection assembly of claim 1, wherein the conduit retainer includes a ring, and wherein the at least one engagement feature includes a plurality of tabs extending radially inwardly from the ring and defining a nominal opening having a cross-sectional profile less than the cross-sectional profile of the conduit end portion, at least a portion of the tabs elastically deformable upon insertion of the conduit end portion into the opening of the connector body for mechanically engaging the conduit end portion.

3. The stub-up connection assembly of claim 1, wherein the conduit retainer includes a ring having a radial split allowing the ring to expand outwardly upon insertion of the conduit end portion into the opening of the connector body.

4. The stub-up connection assembly of claim 1, the connector further comprising a collar releasably coupleable with the connector to releasably retain the conduit retainer relative to the connector.

5. The stub-up connection assembly of claim 1, wherein the conduit access form includes a generally tubular member having a first end configured to be disposed at least partially around the connector and to releasably engage the connector with the generally tubular member.

6. The stub-up connection assembly of claim 5, wherein the first end of the conduit access form includes a flange defining a recess configured to be disposed at least partially around the connector.

7. The stub-up connection assembly of claim 5, wherein the generally tubular member includes at least one region of mechanical weakness facilitating removal of at least a portion of the generally tubular member.

8. The stub-up connection assembly of claim 7, wherein the at least one region of mechanical weakness includes one or more of a generally longitudinal perforation line, a generally helical perforation line and a generally circumferential perforation line on the generally tubular member.

9. The stub-up connection assembly of claim 6, further comprising a plug assembly removably disposed within the generally tubular member to at least partially block the opening of the connector body.

10. A stub-up connection assembly comprising:
a connector including a connector body and a conduit retainer disposed relative to a first end of the connector body and including at least one engagement feature for mechanically engaging a first conduit end portion to resist removal of the first conduit end portion relative to the connector, and including a threaded feature associated with a second end of the connector body, the threaded feature configured for threadably engaging a cooperating threaded feature associated with a second conduit end portion for releasably engaging the second conduit end portion relative to the connector; and
a conduit access form configured to be coupled relative to second end of the connector body and extending longitudinally from the connector, the conduit access form having a cross-sectional profile larger than a cross-sectional profile of the second conduit end portion.

11. The stub-up connection assembly of claim 10, wherein the conduit retainer includes a compression ring and a collar threadably engageable with the first end of the connector body, wherein tightening the collar relative to the connector body reduces a cross-sectional profile of the compression ring to engage the first conduit end portion.

12. The stub-up connection assembly of claim 11, wherein the compression ring includes a split ring having at least one beveled surface, the at least one beveled surface configured to engage a cooperating beveled surface associated with one or more of the connector body and the collar, wherein engagement between at least one beveled surface of the compression ring and the cooperating beveled surface reduces the cross-sectional profile of the compression ring.

13. The stub-up connection assembly of claim 10, wherein the cooperating threaded feature associated with the second conduit end portion includes cooperating threads formed on the second conduit end portion.

14. The stub-up connection assembly of claim 10, wherein the cooperating threaded feature associated with the second conduit end portion includes a thread converter including a first end including the cooperating threaded feature and a second end including an opening configured for receiving the second conduit end portion, and a retention feature for retaining the second conduit end portion relative to the thread converter.

15. The stub-up connection assembly of claim 10, wherein the conduit access form includes at least one of a longitudinal perforation line, a helical perforation line, and a circumferential perforation line facilitating removal of at least a portion of the generally tubular member.

16. The stub-up connection assembly of claim 10, further including a plug, the plug including a first engagement feature configured to releasably retain the plug relative to the conduit access form, and a second engagement feature configured to releasably retain the plug relative to a conduit access-way provided in a concrete body by the conduit access form.

17. A method of providing an in-slab conduit stub-up connection comprising:
coupling a first end of a conduit connector to a in-slab conduit;
coupling a conduit access form with a second end of the conduit connector, the conduit access form extending above an intended slab grade;
pouring a concrete slab surrounding at least a portion of the in-slab conduit and the grab ring connector, the conduit access form extending above the slab; and
removing at least a portion of the conduit access form extending above the slab.

18. The method of claim 17, wherein coupling the first end of the conduit connector to the in-slab conduit includes engaging one-or more grab ring retention features of the conduit connector with the in-slab conduit.

19. The method of claim 17, wherein coupling the first end of the conduit connector to the in-slab conduit includes engaging a compression ring of the conduit connector with the in-slab conduit.

20. The method of claim 17, wherein removing at least a portion of the conduit access form includes tearing the conduit access form along one or more of a longitudinal, a helical, and a circumferential line of mechanical weakness included in the conduit access form.

21. The method of claim 17, further comprising:
inserting at least a portion of an above-slab conduit through an opening defined in the slab by the conduit access form; and
inserting the at least a portion of the above-slab conduit into the second end of the conduit connector to engage the at least a portion of the above-slab conduit with one or more grab ring retention features of the conduit connector to resist removal of the at least a portion of the above-slab conduit relative to the conduit connector.

22. The method of claim 17, further comprising:
inserting at least a portion of an above-slab conduit through an opening defined in the slab by the conduit access form; and
threadably engaging a threaded feature associated with the second end of the connector with a cooperating threaded feature associated with the above-slab conduit to resist removal of the at least a portion of the above-slab conduit relative to the conduit connector.
